(19) United States
(12) Patent Application Publication
(10) Pub. No.: US 2024/0215769 A1
(43) Pub. Date: Jul. 4, 2024

(54) Heat Shield for Temperature Sensing Pan

(71) Applicant: SharkNinja Operating LLC, Needham, MA (US)

(72) Inventors: Macrae Benziger, Dedham, MA (US); Eric Arthur Miller, JR., Somerville, MA (US); Haien Zhou, Suzhou (CN)

(21) Appl. No.: 18/300,785

(22) Filed: Apr. 14, 2023

Related U.S. Application Data
(63) Continuation of application No. PCT/CN2022/143985, filed on Dec. 30, 2022.

(51) Int. Cl. A47J 45/06; G01K 1/12

(52) U.S. Cl. CPC A47J 45/068; G01K 1/12

(57) ABSTRACT

Cookware is provided having a temperature sensing assembly for indicating a temperature of the cookware. In one embodiment, a cooking pan is provided having a pan body with a cooking surface and a heating surface opposite the cooking surface. A handle can be attached to the pan body, and a thermal gauge can be mounted on the handle. A thermal probe can extend from the gauge into the pan body to measure a temperature of the pan body. In some embodiments, a shield can surround at least a portion of the thermal probe to block the thermal probe from radiant heat.

### CROSS REFERENCE TO RELATED APPLICATIONS

This application is a Bypass Continuation Application of International Application No. PCT/CN2022/143985, filed Dec. 30, 2022 and entitled “COOKWARE TEMPERATURE INDICATOR,” the disclosure of which is incorporated herein by reference in its entirety.

### TECHNICAL FIELD

Temperature indicators are provided for use with cookware, such as cookware used on cooktops.

### BACKGROUND

Pots and pans are common forms of cookware used by people throughout the world. Such cookware is typically constructed of metals and includes a main body with a flat bottom and sidewalls to contain food during cooking activities. In some instances, cookware also includes one or more handles to facilitate grasping, thereby reducing the risk of burns.

During cooking activities, cookware is often placed upon a cooktop to receive heat for cooking. A cooktop includes a burner on which the cookware rests. The burner produces heat that is then absorbed and transmitted by the cookware to the items being cooked within the cookware. Many recipes require that a cooktop or burner be set to a specific heat range, for example, medium heat, high heat, or low heat. Different cookware and burner combinations can produce a wide range of cook temperatures for a similar burner settings. For example, a small gas burner set to 50% with one pan may produce a different cooking temperature than an inductive cooktop set to 50% with the same pan. Similarly, a gas burner will produce different cooking temperatures with different sized pans. Traditionally, proper cooking temperatures are matched with burner settings through trial, error, and experience.

Accordingly, there remains a need for improved methods and devices for controlling a temperature of cookware.

### SUMMARY

This disclosure relates to technologies involving displaying temperature of cooking surface on a cookware handle.

In one embodiment, a cooking pan is provided and includes a pan body having a cooking surface and a heating surface opposite the cooking surface. A handle can be attached to the pan body. A hole can extend into the pan body substantially parallel to the cooking surface and the heating surface, and a thermal probe can extend at least partially into the hole. The thermal probe can be configured to detect a temperature of the pan body. The cooking pan can further include a thermal gauge mounted on, and retained by the handle. The thermal gauge and the handle define corresponding profiles that retain the gauge to the handle once the gauge is rotated against the handle. The gauge is also coupled to the thermal probe. The thermal gauge can be configured to indicate a temperature responsive to the temperature detected by the thermal probe.

The pan body can have a variety of configurations. In one embodiment, the pan body can include a first aluminum layer nearer the cooking surface than the heating surface, an inductive layer nearer the heating surface than the cooking surface, and a second aluminum layer between the first aluminum layer and the inductive layer. In certain embodiments, the inductive layer can include martensitic stainless steel.

The hole can be formed at various locations, but in one embodiment the hole can be defined through the second aluminum layer. In certain embodiments, the hole can have a diameter substantially 0.2 mm greater than a diameter of the thermal gauge when the pan body is at room temperature.

In another embodiment, the corresponding profiles can include a shoulder that interlocks with a corresponding shoulder on the thermal gauge to retain the thermal gauge on the handle. The handle can include a first grasping portion and a second portion having the handle hole. In some embodiments the first grasping portion and the second portion extend transverse to one another.

In one embodiment, a cooking pan can have a pan body with a cooking surface and a heating surface opposite the cooking surface. A handle can be coupled to the pan body. A probe can extend into the pan body and can be configured to detect a temperature of the pan body. In some embodiments, a thermal gauge can be mounted in the handle of the pan body and coupled to the probe. The thermal gauge can be configured to indicate a temperature responsive to the temperature detected by the thermal probe.

In some embodiments, the probe can be curved such that a first portion of the probe coupled to the thermal gauge extends transverse to a second portion of the probe extending into the pan body. In some embodiments, the handle includes an opening that can seat the thermal gauge. In some embodiments the thermal gauge can freely movable along a central axis of the opening relative to the handle. Alternatively or in addition, the opening in the handle includes a shoulder that interlocks with a corresponding shoulder on the thermal gauge to retain the thermal gauge in the opening in the handle. In such embodiments, the shoulder on the thermal gauge can be configured to interlock with the shoulder in the opening in the handle by inserting the shoulder on the thermal gauge through the opening in the handle and rotating the thermal gauge.

In one embodiment, a cooking pan has a pan body with a cooking surface and a heating surface opposite the cooking surface. A handle can be coupled to the pan body. A thermal probe can extend between the pan body and the handle. A shield can surround at least a portion of the thermal probe. The shield can be arranged to block the thermal probe from radiant heat.

In some embodiments, the thermal probe includes a curved portion. The shield can be in the form of a boot having upper portion and lower portions extending at an angle relative to one another to extend over the curved portion of the thermal probe. The upper portion of the shield can include opposed lateral sides, while, in some embodiments the lower portion of the shield can include an elongate extension that extends to the pan body.

In some embodiments, the pan body includes a recess configured to receive a portion of the elongate extension of the shield. In some embodiments, the pan body can define a hole. The thermal probe can then be at least partially retained within the hole.

In some embodiments, the shield includes a single unitary piece. In some embodiments, the shield can be attached to the handle. The handle can include an elongate grasping portion and an attachment portion that is attached to a sidewall of the pan body. The shield can extend along the sidewall of the pan body from a lower surface of the attachment portion to the heating surface of the pan body. In some embodiments, a temperature gauge can be mounted in the handle and is coupled to the thermal probe. The temperature gauge can be configured to indicate a temperature of the pan body detected by the thermal body.

In one embodiment, a cooking pan includes a pan body with a base portion having an upper cooking surface and a lower heating surface. A sidewall can extend upward from the base portion. A handle can include attachment portion coupled to the sidewall of the pan body and an elongate grasping portion extending outward from the attachment portion. A shield can be along the sidewall of the pan body and can extend between a lower surface of the attachment portion of the handle and the lower heating surface of the pan body.

In some embodiments, thermal gauge can be mounted to the handle. A thermal probe can extend from the thermal gauge and into the pan body between the cooking surface and the heating surface. The thermal gauge can be configured to indicate a temperature of the pan body detected by the thermal probe.

In some embodiments, the shield can be positioned around the portion of the thermal probe extending from the attachment portion of the handle to the cooking surface to shield the thermal probe from radiant heat. A portion of the shield can extend into the base portion of the pan body. The shield can include an elongate extension and opposed lateral sidewalls extending upward from the elongate extension that can define a hollow cavity between the lateral sidewalls.

### BRIEF DESCRIPTION OF THE FIGURES

These and other features will be more readily understood from the following detailed description taken in conjunction with the accompanying drawings.

FIG. 1A is a top perspective view of one embodiment of a cookware assembly having a pan with a handle and a temperature sensing assembly mounted thereon;

FIG. 1B is a top view showing a gauge of the temperature sensing assembly of FIG. 1A in more detail;

FIG. 2 is a side cross-sectional view of the pan of FIG. 1;

FIG. 3 is a top perspective view of the pan and handle of FIG. 1 with the temperature sensing assembly removed;

FIG. 4A is a perspective view of the temperature sensing assembly of FIG. 1;

FIG. 4B is a side cross-sectional view of another embodiment of temperature sensing assembly;

FIG. 5 is a bottom perspective view of the pan, handle, and temperature sensing assembly of FIG. 1;

FIG. 6A is a side view of the temperature sensing assembly of FIG. 1;

FIG. 6B is a bottom view of the handle of FIG. 1;

FIG. 6C is a bottom perspective view of the temperature sensing assembly and handle of FIG. 1;

FIG. 7A is a top perspective view of another embodiment of a handle for use with the pan of FIG. 1;

FIG. 7B is a top perspective view of the handle of FIG. 7A with another embodiment of a temperature sensing assembly mounted therein;

FIG. 7C is a side cross-section view of the handle and temperature sensing assembly of FIG. 7B;

FIG. 8A is a perspective view of one embodiment of a shield;

FIG. 8B is a side cross sectional view of the shield of FIG. 8A installed on the cookware assembly of FIG. 1;

FIG. 9A is a perspective view of another embodiment of a shield;

FIG. 9B is a perspective view of the shield of FIG. 9A mounted on a pan;

FIG. 10A is a perspective view of another embodiment of a shield;

FIG. 10B is a perspective view of the shield of FIG. 10A mounted on a thermal probe;

FIG. 10C is a rear view of the shield of FIG. 10A;

FIG. 10D is a perspective view of the thermal probe of FIG. 10A mounted on a pan;

FIG. 10E is a perspective view of the thermal probe of FIG. 10A mounted on the pan of FIG. 10D;

FIG. 10F is a perspective view of the shield of FIG. 10B mounted on the thermal probe and pan of FIG. 10D;

FIG. 11A is a perspective view of another embodiment of a shield mounted on a thermal probe;

FIG. 11B is a perspective view of the shield of FIG. 11A mounted on the thermal probe;

FIG. 12A is a perspective view of another embodiment of a shield and thermal probe mounted on a pan;

FIG. 12B is a perspective view of the shield and thermal probe of FIG. 12A;

FIG. 13A is a perspective view of another embodiment of a shield;

FIG. 13B is a perspective view of a shield of FIG. 13A;

FIG. 13C is a perspective view of another embodiment of a handle of a pan;

FIG. 14A is a perspective view of an example mounting bracket that can be used to support the shield to the handle;

FIG. 14B is a perspective view of the bracket of FIG. 14 a with a screws and retainer attached;

FIG. 14C is a side cross-sectional view of a shield and thermal probe mounted to a handle using the bracket of FIG. 14A;

FIG. 14D is a perspective view of a shield and thermal probe mounted to a handle using the bracket of FIG. 14A;

FIG. 14E is a perspective cutaway view of the shield of FIGS. 14C and 14D interfacing with the pan body.

FIG. 15A is a perspective view of another embodiment of a thermal probe; and

FIG. 15B is a perspective view of another embodiment of a thermal probe.

### DETAILED DESCRIPTION

Certain embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting embodiments and that the scope of the present invention is defined solely by the claims. The features illustrated or described in connection with one embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

A temperature sensing assembly is provided for use with various types of cookware, such as a pan. The temperature sensing assembly is configured to read a temperature at the base of a cookware and to display the temperature on a gauge mounted on or adjacent to a handle of the cookware. This enables to user to readily view and monitor the temperature during cooking. Methods and devices are also provided for easily mounting the temperature sensing assembly on the cookware, while still accounting for any deformation of the handle relative to the cookware due to heat and/or flexion. Further, a shield is provided to protect the temperature assembly from thermal damage during use.

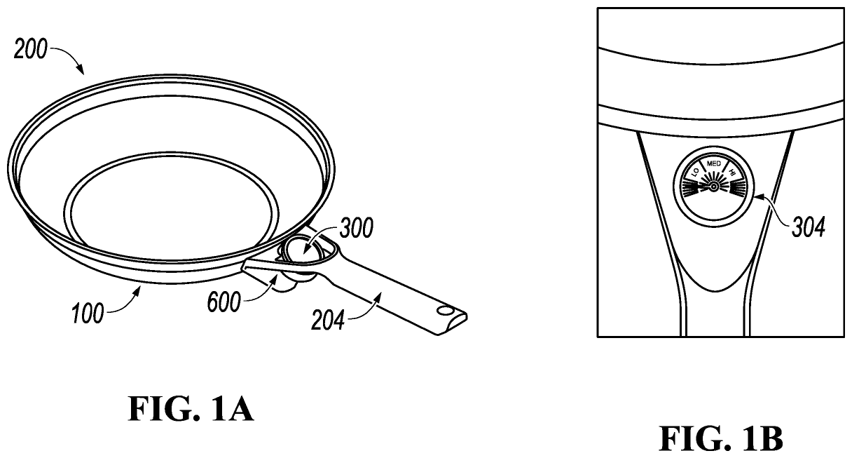

FIGS. 1A and 1B illustrate one embodiment of a cookware assembly 200 that includes a pan 100 having a handle 204 and a temperature sensing assembly 300 coupled thereto. In particular, as shown the temperature sensing assembly 300 includes a gauge 304 that is mounted in the handle 204 to indicate a temperature of the pan. A probe (not shown) extends from the gauge 304 into a base of the pan, as will be discussed in further detail below, for measuring a temperature to be indicated by the gauge. As further shown, a shield 600 is disposed around a portion of the temperature sensing assembly for protecting the temperature sensing assembly from impacts and/or heat.

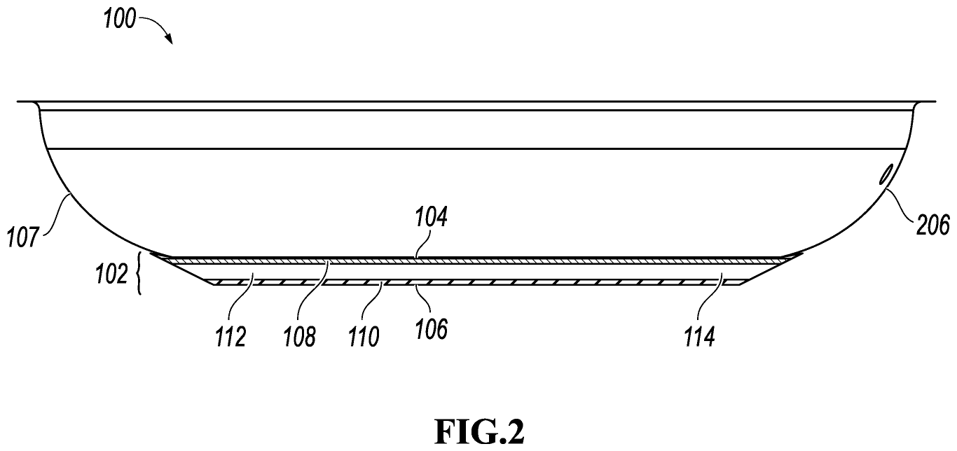

The pan body 100 can have a variety of configurations, and while a pan is shown, a person skilled in the art will appreciate that the temperature sensing assembly disclosed herein can be mounted to any type of cookware, includes various pots, pans, grills, griddles, roasters, etc. In the illustrated embodiment, as shown in more detail in FIG. 2, the pan body has a base portion 102 with an upper cooking surface 104 and a lower heating surface 106. A sidewall 107 extends upward from the base portion 102 for containing food within the pan 100. The cooking surface 104 is configured to receive food items for heating, and the heating surface 106 is configured to rest upon a cook-top surface, such as a gas burner, a conductive electric burner, or an inductive burner. The pan body 100 can include several layers of varying material. In the illustrated embodiment, the upper cooking surface 104 is formed from a material safe for food contact at high heat, such as stainless steel, aluminum alloy, seasoned cast iron, ceramic, and/or a non-stick coating, and the lower heating surface 106 is formed from a material of sufficient strength and heat transfer ability, for example, stainless steel, aluminum alloy, seasoned cast iron, ceramic and/or a ruggedizing coating. The pan body 100 includes a first aluminum, or aluminum alloy, layer 108 that is adjacent to the cooking surface 104, and an inductive layer 110 that is adjacent to the heating surface 106 or that defines a portion of the heating surface 106. The inductive layer allows the pan body to interact (for example, be heated by) an inductive cooktop. The inductive layer can be made-up of a magnetic material, such as a martensitic stainless steel. Alternatively, or in addition, the inductive layer can include a ferrous material, such as cast iron. In some embodiments, an inductive coating can be used without departing from this disclosure. In some embodiments, a second aluminum, or aluminum alloy, layer 112 can be included between the first aluminum layer 108 and the inductive layer 110. The described layers can be manufactured and bonded in a variety of ways, for example, by press-fitting the layers into a unitary piece.

Regardless of the layering, the various layers make-up the base 102 of the pan body 100. The base 102 transfers heat from the heating surface 106 to the cooking surface 104. In some embodiments, the base 102 is configured to disperse heat more evenly across the cooking surface 104 than would be feasible with a single-layer pan body.

As explained above, the temperature sensing assembly is configured to measure of temperature of the pan body. Accordingly, the pan body 100 can define a blind hole 114 extending therein that is configured to receive a portion of the probe on the temperature sensing assembly, as will be discussed below. The hole 114 can be formed at various locations, but in the embodiment as shown in FIG. 2 the hole 114 extends substantially parallel to the cooking surface 104 and the heating surface 106. The hole 114 preferably does not penetrate the cooking surface 104 or the heating surface 106. In some embodiments, the hole can be defined through and/or by the second aluminum layer 112. Such a hole 114 can be produced in a variety of ways. For example, the hole 114 can be formed with a single drill pass using a guided drill bit. In other embodiments, the hole 114 can be pre-formed in the second aluminum layer 112 prior to assembly with other layers.

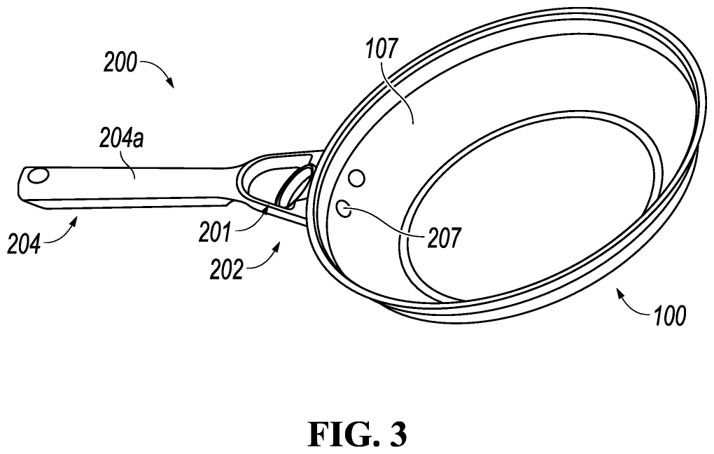

As explained above, the pan body can further include a handle 204 to facilitate grasping. As shown in more detail in FIG. 3, in one embodiment the handle 204 can have a generally elongate configuration with an attachment portion 202 configured to couple or attach to the sidewall 107 of the pan body 100 and an elongate grasping portion 204a extending outward from the attachment portion 202. While various techniques can be used to mate the attachment portion 202 to the pan body, in one embodiment as shown the attachment portion 202 can include one or more holes 206 therein. The holes 206 can align with corresponding holes in the sidewall 107, allowing the handle 204 to be attached to the pan body 100 using a fastener, such as a rivet 207, screw, or the like. Other fastening techniques can be used without departing from this disclosure.

As further shown in FIG. 3, the attachment portion can include an opening 201 adapted to seat the gauge of the temperature sensing assembly. The configuration of the opening 201 can vary depending on the configuration of the temperature gauge. In the illustrated embodiment, the opening is generally semi-circular. As will be explained in more detail below, the opening can include features to aid in seating the gauge 304.

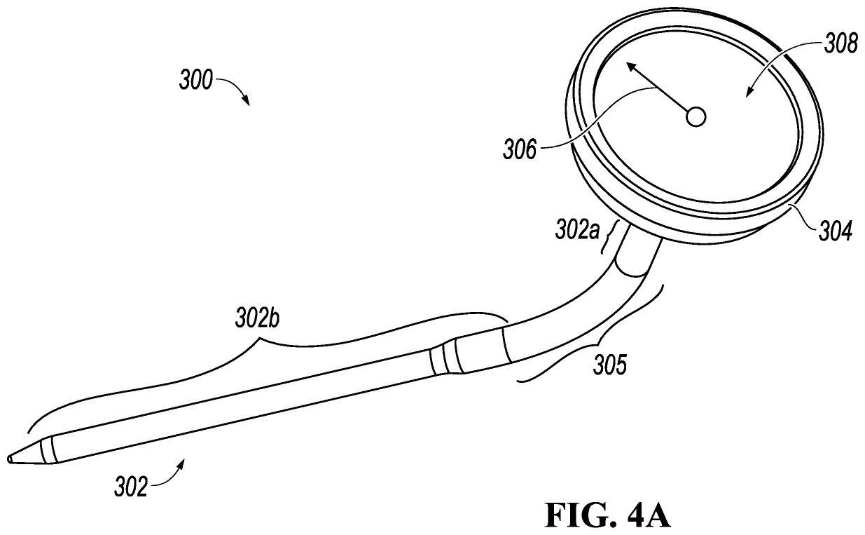

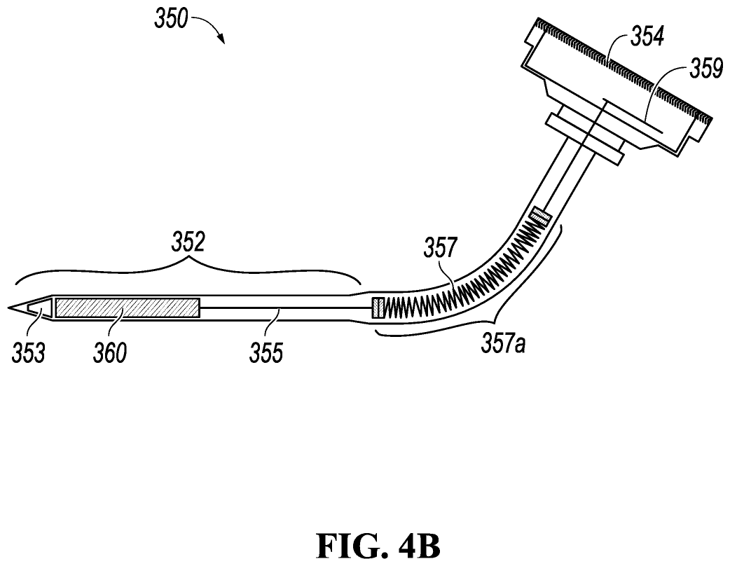

FIG. 4A illustrates the temperature sensing assembly 300, including the thermal probe 302 and gauge 304, in more detail. While the probe 302 can have a variety of shapes and sizes, it is preferably shaped to extend from the gauge to the bottom of the pan. Accordingly, in an embodiment, the probe 302 can be curved such that first and second substantially linear portions 302a, 302b of the probe 302 extend at an angle relative to one another with a curved portion 305 there between. The angle can vary depending on the configuration of the pan and the handle. The thermal gauge 304 can be formed on or mated to the end of the first portion 302a, and it can include features to indicate a temperature of the pan. In the illustrated embodiment, the gauge 304 includes a dial 308 with graduated markings (not shown) corresponding to a temperature sensed by the thermal probe 302. In some embodiments, the dial can be marked to indicate temperature ranges, for example, low heat, medium heat, and high heat, as shown in FIG. 1B. The dial can also be marked with temperature ranges that are considered too hot or too cold for the pan. For example, in instances where the pan is a non-stick pan, the non-stick coating works best within a specified temperature range. In cases where the temperature is too low, the non-stick coating may not function properly. In cases where the temperature is too high, the non-stick coating may degrade. Having these temperature ranges on the dial allows for a user to keep the pan within an ideal temperature range and extend a life of the pan.

In certain embodiments, a bimetallic strip can be used to control the gauge 304. FIG. 4B illustrates one embodiment of a temperature sensing assembly 350 having a thermal probe 352 with a coiled or wound bimetallic strip 360 that is coupled to an indication needle 359 on the gauge 354. In particular, the coiled or wound bimetallic strip 360 is positioned inside of the probe 352, with one end attached proximate the tip 353. Such an attachment may be through a weld, braze, adhesive, mechanical, or other attachment means. A wire 355 may connect the coiled or wound bimetallic strip 360 to an extension spring 357 that extends between the wire and the temperature gauge 354. Each end of the extension spring 357 can include a coupling 357a for connecting the extension spring 357 to the wires. The coupling may be through a weld, braze, adhesive, mechanical, or other attachment means. In such an embodiment, differences in thermal expansion can cause the bimetallic strip to rotate, which in turn causes rotation of the extension spring to cause movement of the indication needle. In another embodiment (not shown), the bimetallic coil can continue along the entire length of the probe and can couple directly to the temperature gauge, such that a single coil rotates to move the dial. While primarily described with a bimetallic strip 360, other temperature sensing and display systems can be used without departing from this disclosure. For example, a graduated indicator with an expandable fluid or a thermocouple can be used. While illustrated and described as separate embodiments, in some instances, the temperature sensing assembly 350 can be used in place of temperature sensing assembly 300 without departing from this disclosure.

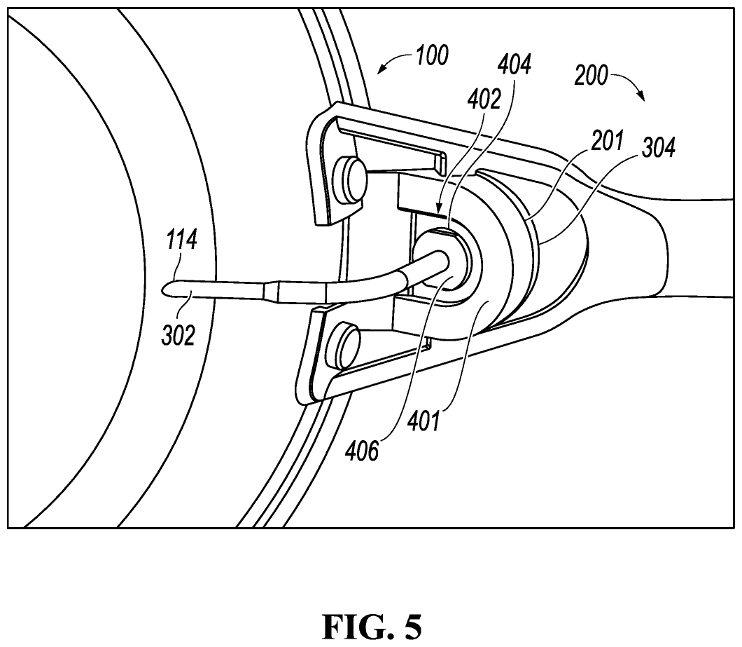

The temperature sensing assembly 300 can be mounted to the pan using various techniques. In one embodiment, as shown in FIG. 5, the gauge 304 can be mounted in the opening 201 in the handle 204, and the thermal probe 302 can extend from the handle to the pan body 100 and at least partially into the hole 114. The thermal probe 302 preferably extends a distance into the pan body 100 that is effective to measure a representative temperature of the cooking surface 104, for example it can extend to a position substantially three inches from the center of the pan body 100 or substantially 55 millimeters (mm) from a pan body 100 edge (within standard manufacturing tolerances). Such distances can vary depending upon the size of the pan body 100. Generally, the tip of thermal probe 302 may be located approximately ⅓ of the diameter of the pan bottom from the center of the pan. As different burner styles distribute heat differently, such a distance is an adequate representation of cooking surface temperatures across a variety of burner styles, for example, conductive electric burners, inductive electric burners, or gas burners. The hole 114 can be sized to receive and at least partially retain the thermal probe 302 both in depth and diameter. For example, the hole 114 can be slightly deeper than the length of the probe 302 that penetrates into the pan body 100. The hole 114 diameter can be slightly larger than a diameter of the thermal probe 302, for example, by substantially 0.2 millimeters (mm) (within standard manufacturing tolerances at room temperature). During use, after exposure to heat, thermal expansion may reduce the size of the hole 114 such that it creates a friction-tight fit around the probe 302. Such contact can improve temperature reading accuracy due to improved thermal coupling from the direct contact with the base 102 (FIG. 2).

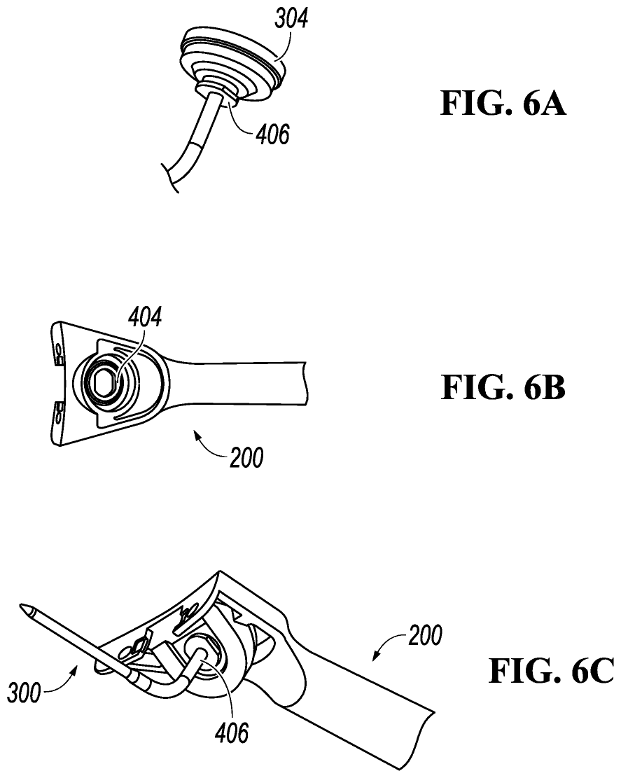

In order to mount the thermal gauge 304 to the handle 204, as indicated above the handle 204 can define a handle opening 201. In one embodiment, as shown, the handle opening 201 can include a support structure 401 positioned at least partially therein and having an upper surface configured to seat the gauge 304. The support structure 401 can include a hole 402 extending there through for receiving the probe. In some embodiments, the gauge 304 and the support structure 401 can include corresponding profiles that retain the gauge 304 to the handle 204 once the gauge is rotated into place. For example, in some embodiments, a shoulder 404 can be formed around the hole 402 adjacent the lower surface of the support structure 401. The shoulder 404 can be configured to interlock with a corresponding shoulder 406 on the thermal gauge 304 to retain the thermal gauge 304 to the handle. The interlocking shoulders 404, 406 are shown in more detail in FIGS. 6A-6C. As shown in FIG. 6A, the shoulder 406 on the temperature sensing assembly 300 is positioned just beneath the gauge 304 at the top end of the probe. The shoulder 406 is in the form of a radially extending flange having an oblong configuration with two curved ends connecting two opposed straight sides, with the straight sides being longer in length than the curved ends. The shoulder 404 on the handle, shown in FIG. 6B, includes an oblong opening having a complementary shape that is configured to receive the shoulder 406 on the gauge. Once the shoulder 406 on the gauge is passed through the handle hole 402, from the upper surface to the lower surface, the temperature sensing assembly can be rotated about 90 degrees to cause the shoulder 406 to extend underneath and to engage the shoulder 404 on the handle. In other words, the shoulder 406 on the gauge is rotated to be misaligned with the shoulder on the handle to prevent removable of the gauge from the handle, as shown in FIG. 6C. Once the gauge 304 and thermal probe 302 are attached to the handle, the probe can be inserted into the pan body 100 and the handle can be mounted to the pan body to fully assemble the device. A person skilled in the art will appreciate that other keying features or other techniques can be used to mate the gauge to the shoulder. That is, other keying or rotatable coupling features can be used without departing from this disclosure, for example, a threaded connection, a snap-in connection, or other bayonet-style connections can be used.

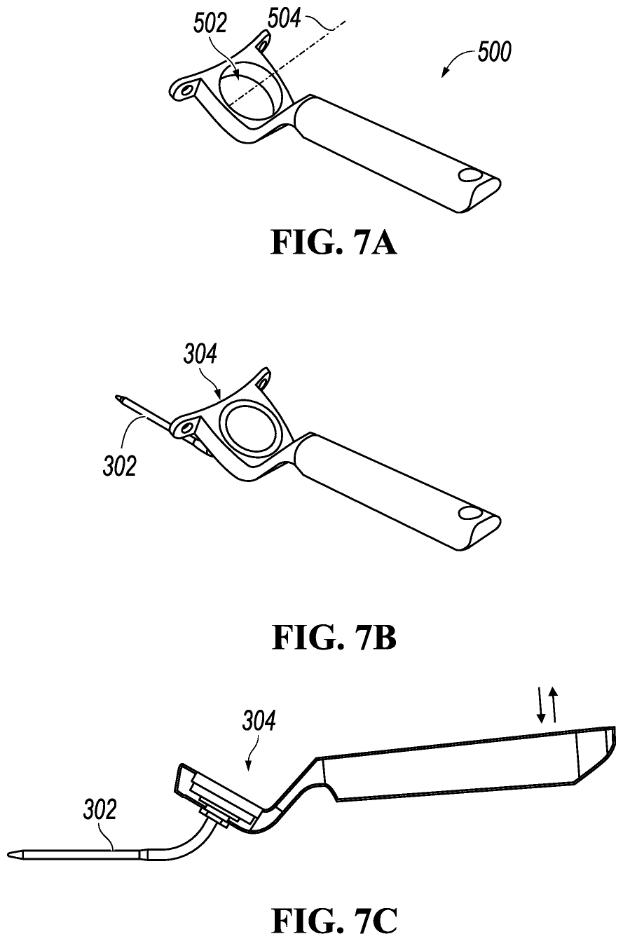

In other embodiments, as shown in FIGS. 7A-7C, the gauge can be free-floating relative to the handle. The handle and gauge interface illustrated in FIGS. 7A-7C is substantially similar to embodiments previously described with the exception of any differences described herein. As shown, the handle 500 includes a handle opening 502 that is slightly larger in diameter than the gauge 304. In this embodiment, the opening is cylindrical so that is fully seats the gauge. The opening does not include any mating features to engage the gauge. As a result, the gauge is able to move freely along a central axis 504 of the handle opening 502. That is, transfer of any flexion between the handle 500 and the pan body 100 to the gauge 304 is mitigated or reduced, so the handle 500 and the gauge 304 are freely movable relative to one another along the central axis 504 of the handle opening 502. In such an embodiment, the gauge 304 is supported by the coupling of the thermal probe 302 to the pan body. During assembly, this can be achieved by inserting the thermal probe 302 through the handle opening 502 and into the hole 114 in the pan body, and then mounting the handle to the pan body 100.

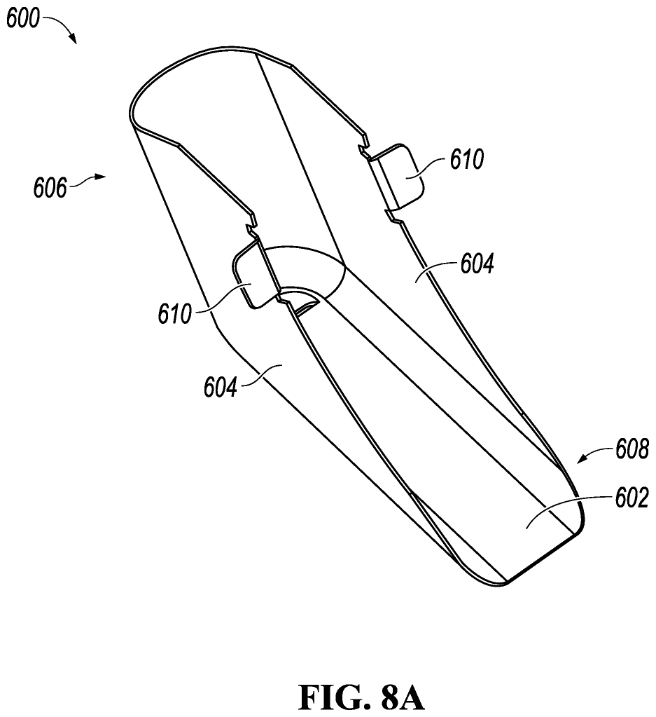

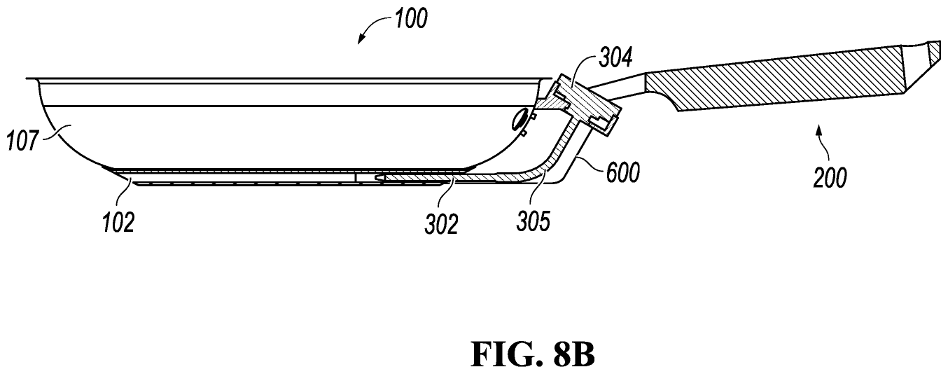

The cookware assembly disclosed herein can also include a shield for protecting the temperature sensing assembly. FIG. 8A illustrates the shield 600 of FIG. 1 in more detail. As will be appreciated, a portion of the thermal probe 302 extending from the pan body to the thermal gauge 304 is exposed and can be damaged by excess radiant heat and/or impacts. To mitigate this, the shield 600 can be configured to surround at least a portion of the thermal probe to thereby block the thermal probe from radiant heat and potential impacts. While the shield 600 can have a variety of shapes and sizes, in the illustrated embodiment the shield 600 is in the form of a hollow boot, with an elongated base or extension 602 having opposed lateral sidewalls 604 extending upward from the elongate extension to define a hollow cavity therebetween. The curved portion 305 of the thermal probe 302 can be received by the hollow cavity when the shield is mounted on the pan. In other words, the shield 600 is in the form of a boot having upper portion 606 and lower portions 608 extending at an angle relative to one another to extend over at least the curved portion 305 of the thermal probe 302.

The shield 600 can be constructed in a variety of ways. For example, in some embodiments, the shield can be press formed as a single unitary piece. In some embodiments, the shield 600 is constructed from multiple pieces that are welded, braised, or otherwise fastened together.

When fully assembly to the pan, as shown in FIG. 8B, the shield 600 can be positioned along the sidewall 107 of the pan body 100 such that it extends between a lower surface of the attachment portion 202 of the handle and the lower heating surface 106 of the pan body 100. This arrangement positions the shield 600 around the curved portion 305 of the thermal probe 302 extending from the attachment portion 202 of the handle 204 to the base 102 in order to shield the thermal probe 302 from radiant heat or impacts. In some embodiments, the shield 600 can be welded, brazed, adhered, or otherwise attached to the sidewall as to prevent and/or reduce fluid ingress between the shield 600 and the sidewall 107

In some embodiments, the shield 600 can be attached to the handle 204. Various mating features can be used, such as tabs 610 formed on the shield. The tabs 610 can be configured to extend into corresponding slots (not shown) formed in the handle 204 or the pan body. Alternatively, or in addition, the handle 204 can press the tabs 610 against the sidewall 107 of the pan body to retain the shield to the handle 204. In other embodiments, the shield 600 may be solely attached to the handle 204, thus allowing the shield 600 to flex in unison with the handle relative to the pan body 100 during active use.

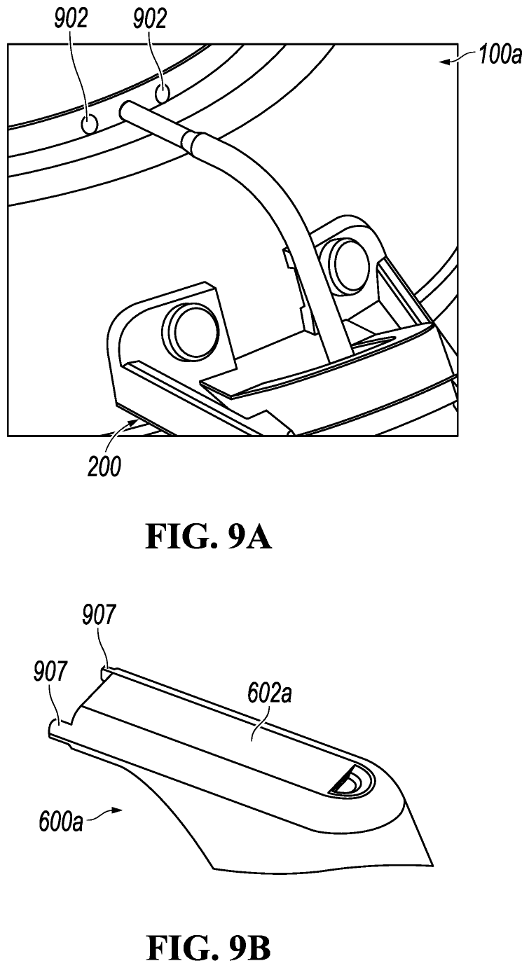

In other embodiments, as illustrated in FIGS. 9A-9B, a portion of the shield 600a can extend into the base portion of the pan body 100a. In such an embodiment, the pan body 100a can include one or more recesses 902 defined by the pan body 100a and configured to receive a portion of the elongate extension 602a of the shield 600a, for example, the tabs 907. Such embodiments can couple the shield to both the pan body 100 and the handle 204. Such coupling can increase the stiffness of the handle relative to the pan body 100.

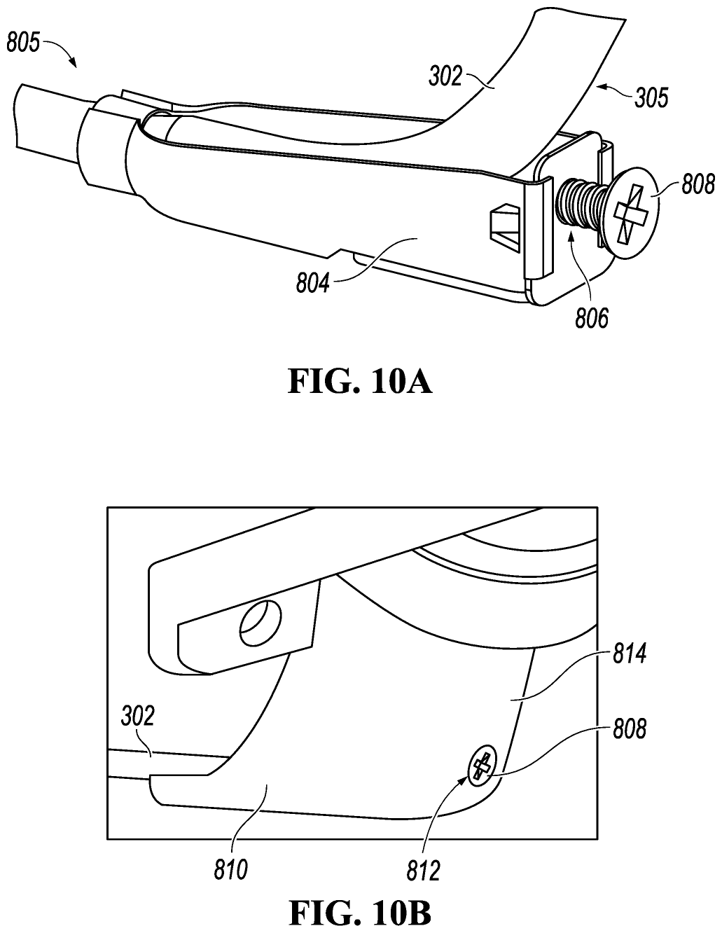

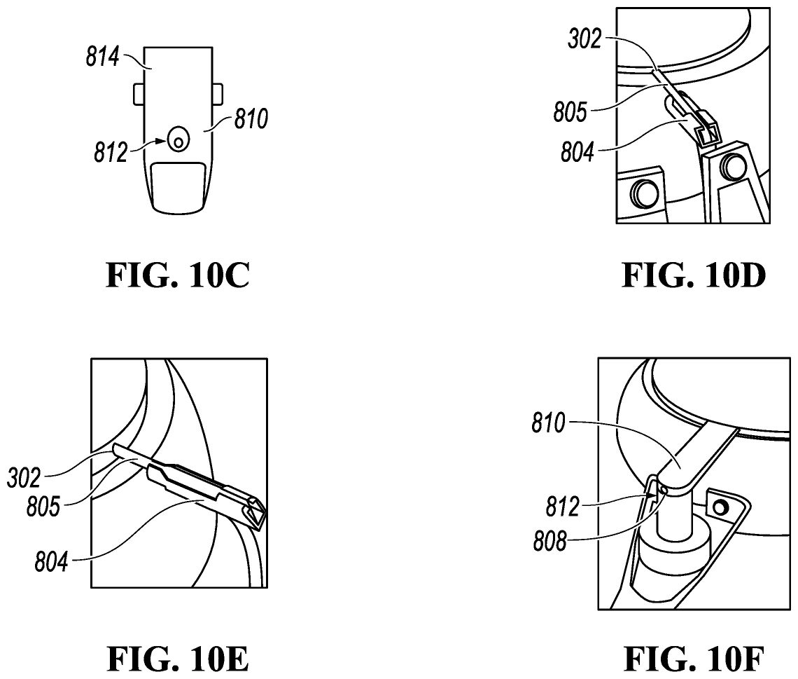

In other embodiments, as illustrated in FIGS. 10A-10F, the thermal probe 302 can include a bracket 804. The illustrated bracket 804 includes a thru-hole 805 arranged on a first end of the bracket 804, and a thru-bore 806 arranged on a second end of the bracket 804, opposite the thru-hole 805. The thru-hole 805 is formed in a shape corresponding to an outer diameter of the thermal probe 802. The thermal probe 302 can be threaded through the thru-hole 805 to position a portion of the curved portion 305 within the bracket 804. The thru-bore 806 can be configured to receive a screw 808 or other attachment feature to facilitate mating of the shield to the bracket 804. In one embodiment, the thru-bore 806 can be a threaded hole.

As further shown, a shield 810 is configured to cover the bracket 804 and the thermal probe 302 in order to protect the thermal probe 302. The shield 810 can be substantially similar to the shield 600, so like components are not described in detail. The illustrated shield 810 includes a hole 812 arranged on an upper portion 814 of the shield 810 and configured to receive the screw 808. As the shield 810 is arranged over the bracket 804, the thru-bore 806 and the hole 812 align. This alignment allows the screw 808 to pass through the hole 812 and into the thru-bore 806. The shield 810 is secured to the thermal probe 302 via the bracket 804 when the screw 808 is arranged in both the thru-bore 806 and the hole 812.

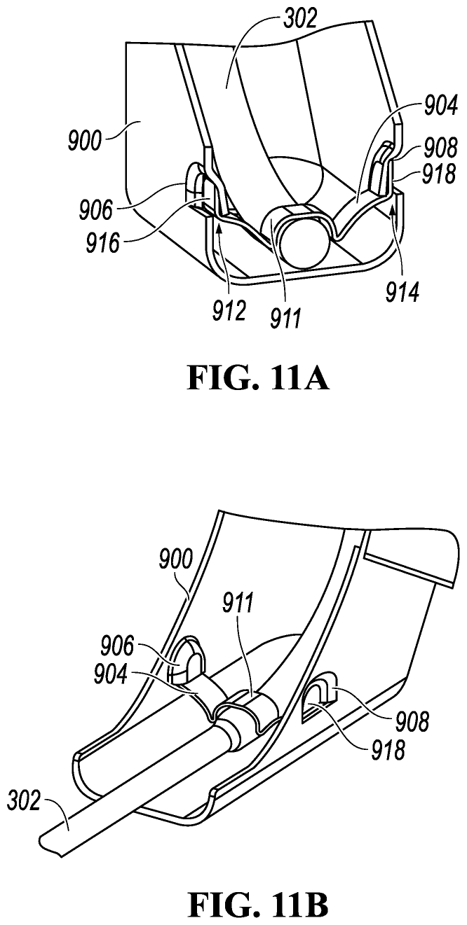

In other embodiments, as illustrated in FIGS. 11A-11B, the thermal probe 302 can be secured relative to a shield using a spring member 904. The thermal probe 302 is held within a shield 900 by the spring member 904 in order to support the thermal probe 302. The shield 900 is substantially similar to shield 600, so like components are not described in detail. The illustrated shield 900 includes a first indent 906 and a second indent 908 arranged in opposed lateral sidewalls 910. The indents 906, 908 are aligned with each other along the lateral sidewalls 910, and arranged such that gaps 912, 914 are formed in the lateral sidewalls 910.

The spring member 904 is arranged within the shield 900 and includes a curved section 911 and tabs 916, 918 arranged on opposite side of the curved section 911. The tabs 916, 918 are correspondingly shaped to match the shape of the indents 906, 908. The gaps 912, 914 are configured to receive tabs 916, 918 of the spring member 904 in order to hold the thermal probe 302 in place within the shield 900. In another embodiment, the spring member 904 can be welded within the shield 900. The curved section 911 can be shaped to correspond to an outer diameter of the thermal probe 302. The spring member 904 can push down on the thermal probe 302, securing the thermal probe relative to the shield 900.

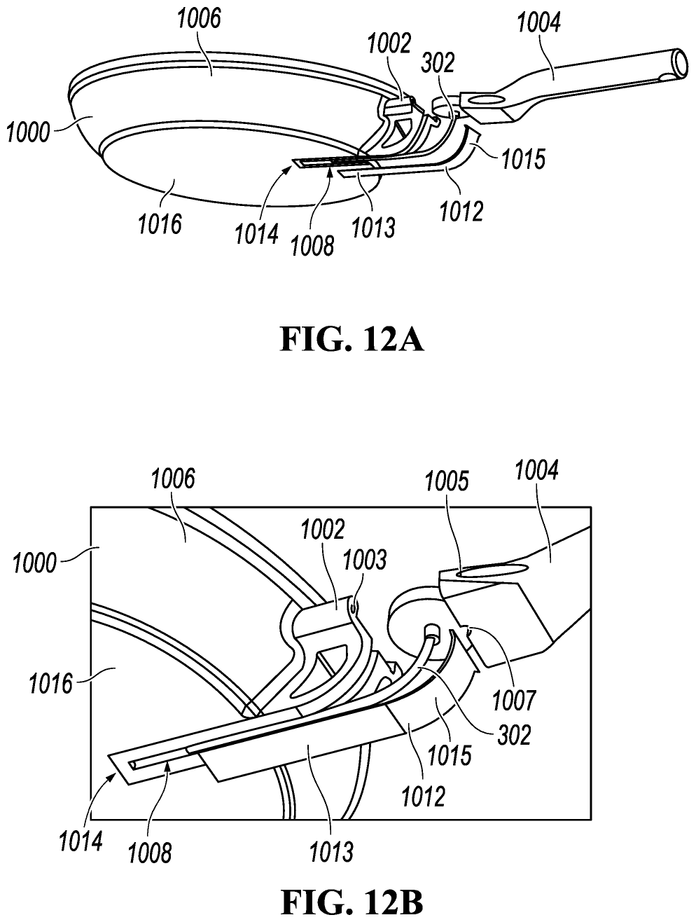

In other embodiments, as illustrated in FIGS. 12A-12B, the thermal probe 302 can be secured directly within a pan. As shown, a pan 1000 can include a bracket 1002 and a handle 1004. The bracket 1002 can be positioned on a sidewall 1006 of the pan 1000 and can extend outward from the sidewall 1006. The bracket 1002 can include a channel 1008 cast directly into the bracket 1002. The channel 1008 can extend along the bracket 1002 and into the base portion 1010 of the pan 1000. As illustrated in FIGS. 12A-12B, the channel 1008 is configured to receive the thermal probe 302. The thermal probe 302 is secured within the channel 1008 by the handle 1004 being connected to the bracket 1002. The handle 1004 secures to the bracket 1002 using bolts (not shown) arranged within thru-holes 1003 on the bracket 1002 and thru-holes 1005 on the handle 1004. Additionally, the handle 1004 includes an indent 1007 that is shaped to correspond to the thermal probe 302 so the handle 1004 is arranged flush with the bracket 1002 with the thermal probe 302 positioned within the channel 1008.

A shroud 1012 can be configured to secure the thermal probe 302 within the channel 1008. The illustrated shroud 1012 is shaped to correspond to the outer edge of the bracket 1002 and the base portion 1010. The shroud includes a flat portion 1013 and a curved portion 1015. Additionally, the base portion 1010 can include an indent 1014 that corresponds to the shape of the flat portion 1013 of the shroud 1012 such that the base portion 1010 includes a fully flat bottom surface 1016 with the shroud 1012 positioned within the indent 1014. The shroud 1012 can be secured within the indent 1014 using pressing, welding, or brazing techniques. The shroud 1012 can be configured to protect the thermal probe 302 while installed within the pan 1000. While a shroud is shown in use with the pan 1000, the thermal probe 302 can be secured within the channel of the pan without the addition of the shroud to hold the thermal probe in place.

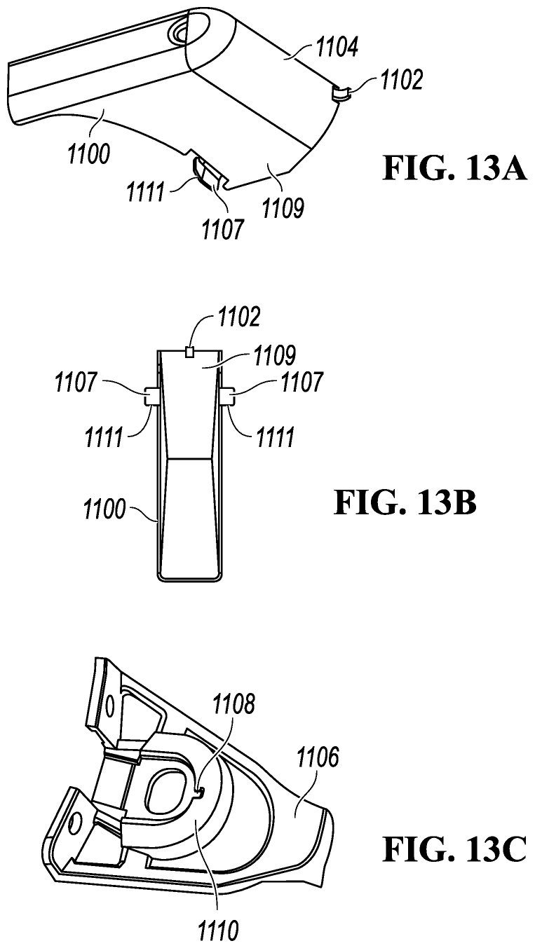

In addition to securement tabs arranged on the lateral sidewalls of a shield, additional tabs can be included to provide a more rigid connection between a shield and a handle. FIGS. 13A-13C illustrate another embodiment of a shield 1100 used to protect a thermal probe. The shield 1100 is substantially similar to shield 600, so like components are not described in detail. The shield 1100 includes a central tab 1102 extending from an upper portion 1104. The tab 1102 may be bent at a 90-degree angle and is configured to be received within a handle. Additionally, tabs 1107 are arranged on the sidewalls 1109 of the shield 1100. A spring tab 1111 is formed on each of the tabs 1107 and is configured to bias the shield 1100 into contact with a pan (not shown) when installed on the handle.

FIG. 13C illustrates an embodiment of a handle 1106 that is substantially similar to the handle 204, so like components are not described in detail. The handle 1106 includes an indent 1108 arranged in a bottom surface 1110 of the handle 1106 and corresponding to the shape of the tab 1102. The tab 1102 is received in the indent 1108 in order to reduce rotational movement of the shield 1100 relative to the handle 1106.

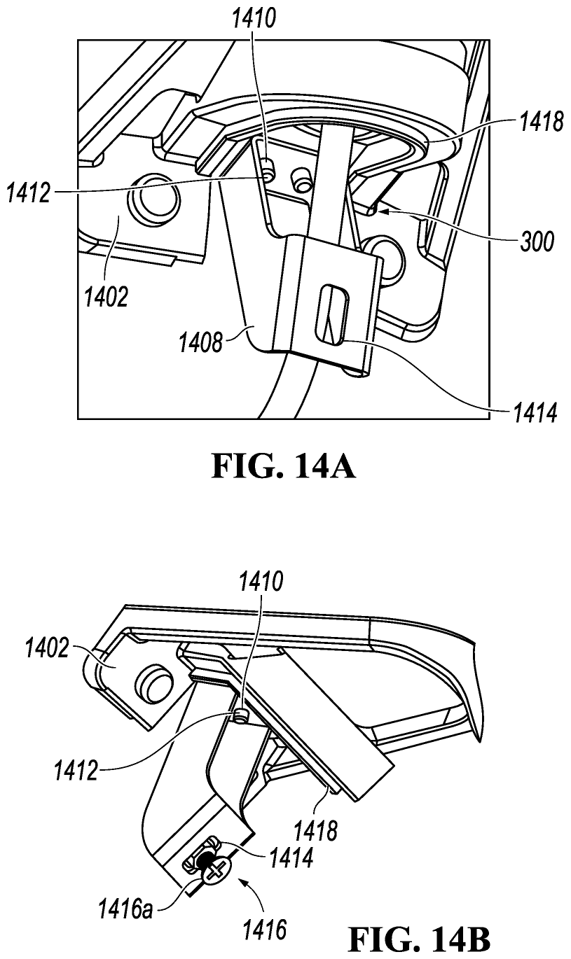

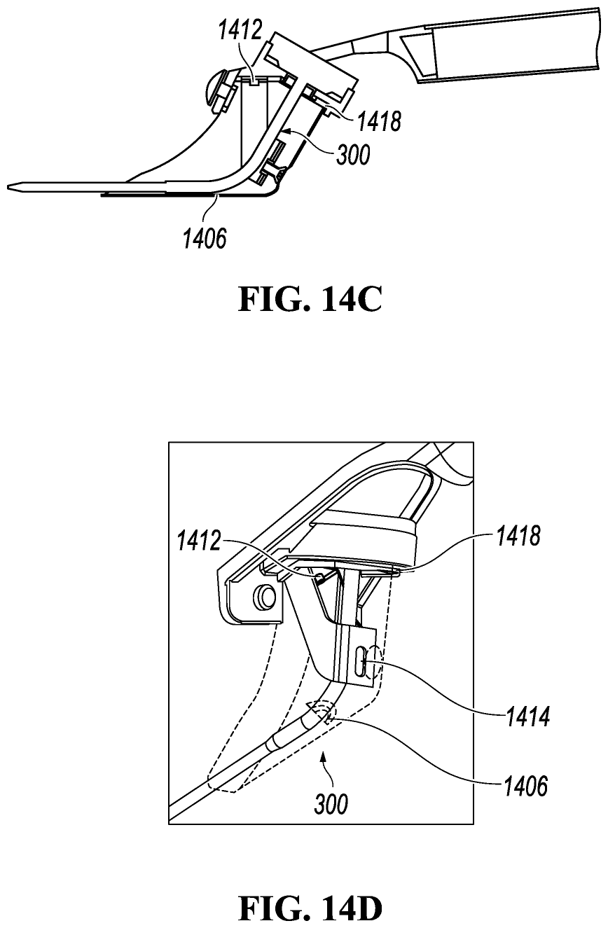

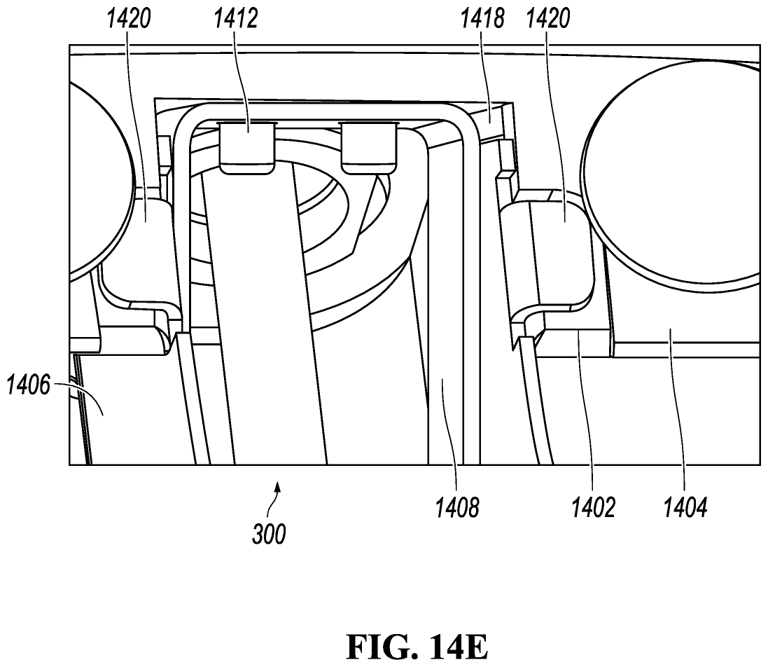

Alternatively or in addition to the previously described embodiments, a bracket configured to attach the shield to the handle can be included. In such embodiment, illustrated in FIGS. 14A-14E, the temperature sensing assembly 300 can be attached to the handle 1402, the handle 1402 can be riveted to the pan body 1404, and then the shield 1406 can be attached to a bracket 1408 mounted to the handle 1402. The handle 1402, pan body 1404, shield 1406 are substantially similar to the handle 204, the pan body 100, and the shield 600, respectively, with the exception of any differences described herein. The bracket 1408 itself defines one or more holes 1410 at a first end of the bracket 1408 to receive one or more studs 1412 from the handle 1402. Once the studs 1412 have been received, the studs 1412 are then welded, pressed to plastically deform and create an interference with the bracket (similar to a rivet), or are otherwise attached to the bracket 1408.

At a second end of the bracket 1408 is a slot 1414 defined by the bracket 1408. The slot 1414 is configured to receive a fastener 1416. In the illustrated embodiment, the fastener includes a Philips-head screw 1416a and a nut 1416b configured to rest within the slot 1414. The Philips-head screw 1416a is used to secure the shield 1406 to the bracket 1408. In some embodiments, security screws, torque-head screws, slotted screws, or any other screw can be used in lieu of the illustrated Phillips-head screw 1416a. While primarily described as using a screw and nut arrangement, other fastening arrangements can be used without departing from this disclosure, for example, a threaded hole can be defined by the bracket in lieu of the slot 1414. Alternatively or in addition, a metallic clip, pin, or other fastener can be used in lieu of a screw.

In some embodiments, an additional U-shaped spacer 1418 can be added to the handle 1402. The spacer 1418 is arranged to rest between the handle 1402 and the shield 1406 and fills any gap that may be present between the handle 1402 and the shield 1406. The spacer can be formed in a as a unitary part of the handle 1402, for example, the spacer 1418 can be pressed or stamped into the handle 1402. Alternatively or in addition in some embodiments, the spacer 1418 can be added as a separate piece, then be attached to the handle, for example by brazing, welding, adhering, or fastening. The spacer 1418 can define a variety of different profiles, for example, in some embodiments, the spacer 1418 can define embossed profile. That is, the profile is substantially flat and raised. Alternatively or in addition, the spacer can define a channel configured to receive the shield 1406.

In some embodiments, for example, the embodiment shown in FIG. 14E, the shield 1406 include tabs 1420 that interfere with the handle 1402. Such an interference helps keep the shield 1406 substantially flush (for example, a gap of a few millimeters or less) with the pan body 1404. In some embodiments, during installation, the tabs are inserted between the pan body 1404 and the handle 1402 prior to the screw 1416a being installed to secure the shield 1406.

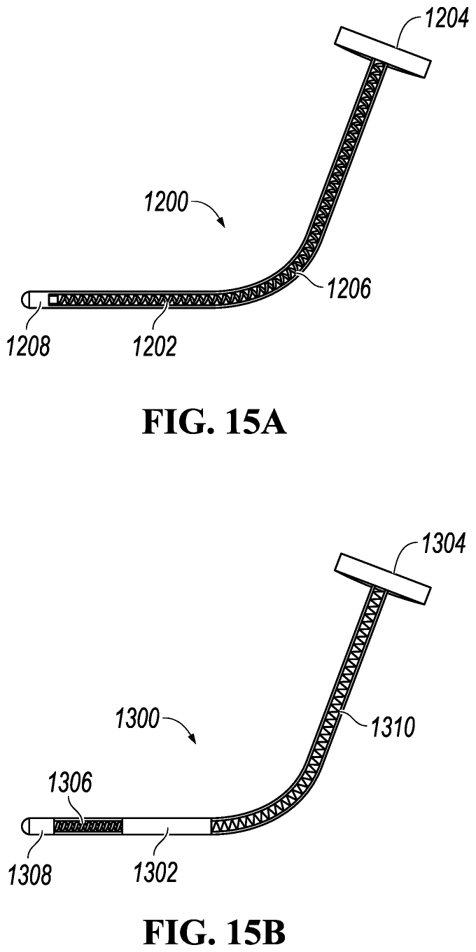

FIG. 15A illustrates another embodiment of a temperature sensing assembly 1200 including a thermal probe 1202 and a gauge 1204. The temperature sensing assembly 1200 is similar to temperature sensing assembly 350, and therefore like components are not discussed in detail. A coiled or wound bimetallic strip 1206 is arranged within the temperature probe 1202 and is coupled to an indication needle (not shown) on the gauge 1204. The other end of the bimetallic strip 1206 is attached proximate the tip 1208 of the thermal probe 1202. The bimetallic strip 1206 can act as a flex shaft inside the thermal probe 1202, without the need of an extension spring, since the bimetallic strip 1206 can navigate the curved thermal probe 1202 while still transmitting motion to the gauge 1204 from the bimetallic strip 1206.

In other embodiments, a spring can be used to replace the wire arranged between the bimetallic coil and the extension spring in the temperature sensing assembly 350. As illustrated in FIG. 15B, a temperature sensing assembly 1300 is shown including a thermal probe 1302 and a gauge 1304. The temperature sensing assembly 1300 is similar to temperature sensing assembly 350, and therefore like components are not discussed in detail. Arranged within the temperature probe 1302 is a coiled or wound bimetallic strip 1306 that is coupled to an indication needle (not shown) on the gauge 1304 via a spring 1310. The other end of the bimetallic strip 1306 is attached proximate the tip 1308 of the thermal probe 1302. The spring 1310 can act as a flex shaft inside the thermal probe 1302 and connect the bimetallic strip 1306 to the gauge 1304, without the need of a wire extending between the bimetallic strip 1306 and the spring 1310, since the spring 1310 can navigate the curved thermal probe 1302 while still transmitting motion to the gauge 1304 from the bimetallic strip 1306.

While this disclosure contains many specific embodiment details, these should not be construed as limitations on the scope of what may be claimed, but rather as descriptions of features specific to particular embodiments. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

Other embodiments can be within the scope of the following claims.

What is claimed is:

1-13. (canceled)

14. A cooking pan, comprising:
a pan body comprising a cooking surface and a heating surface opposite the cooking surface;
a handle coupled to the pan body;
a thermal probe extending between the pan body and the handle; and
a shield surrounding at least a portion of the thermal probe, the shield arranged to block the thermal probe from at least one of radiant heat and impacts.

15. The cooking pan of claim 14, wherein the thermal probe includes a curved portion, and the shield is in the form of a boot having upper and lower portions extending at an angle relative to one another to extend over the curved portion of the thermal probe.

16. The cooking pan of claim 15, wherein the upper portion of the shield includes opposed lateral sides, and the lower portion of the shield includes an elongate extension that extends to the pan body.

17. The cooking pan of claim 16, wherein the pan body includes a recess configured to receive a portion of the elongate extension of the shield.

18. The cooking pan of claim 14, wherein the shield is attached to the handle.

19. The cooking pan of claim 14, further comprising a temperature gauge mounted in the handle and coupled to the thermal probe, the temperature gauge being configured to indicate a temperature of the pan body detected by the thermal body.

20. The cooking pan of claim 14, wherein the pan body defines a hole, the thermal probe being at least partially retained within the hole.

21. The cooking pan of claim 14, wherein the shield comprises a single unitary piece.

22. The cooking pan of claim 14, wherein the handle includes an elongate grasping portion and an attachment portion that is attached to a sidewall of the pan body, the shield extending along the sidewall of the pan body from a lower surface of the attachment portion to the heating surface of the pan body.

23. A cooking pan, comprising:
a pan body having a base portion with an upper cooking surface and a lower heating surface, and a sidewall extending upward from the base portion;
a handle having an attachment portion coupled to the sidewall of the pan body and an elongate grasping portion extending outward from the attachment portion;
a shield positioned along the sidewall of the pan body and extending between a lower surface of the attachment portion of the handle and the lower heating surface of the pan body.

24. The cooking pan of claim 23, further comprising a thermal gauge mounted to the handle, and thermal probe extending from the thermal gauge and into the pan body between the cooking surface and the heating surface, the thermal gauge being configured to indicate a temperature of the pan body detected by the thermal probe.

25. The cooking pan of claim 24, wherein the shield is positioned around the portion of the thermal probe extending from the attachment portion of the handle to the cooking surface to shield the thermal probe from radiant heat.

26. The cooking pan of claim 23, wherein a portion of the shield extends into the base portion of the pan body.

27. The cooking pan of claim 23, wherein the shield includes an elongate extension and opposed lateral sidewalls extending upward from the elongate extension and defining a hollow cavity therebetween.
